(19) United States
(12) Patent Application Publication
(10) Pub. No.: US 2008/0120217 A1
(43) Pub. Date: May 22, 2008

(54) SYSTEM AND METHOD FOR CALCULATING INTRA-PERIOD VOLATILITY

(75) Inventors: Matt Gilbert Amberson, Chicago, IL (US); Brian Patrick Pierce, Aurora, IL (US)

Correspondence Address: BARNES & THORNBURG LLP, P.O. BOX 2786, CHICAGO, IL, 60690-2786, US

(73) Assignee: OPTION RESEARCH AND TECHNOLOGY SERVICES, LLC, Chicago, IL (US)

(21) Appl. No.: 12/019,510

(22) Filed: Jan. 24, 2008

Related U.S. Application Data
(63) Continuation of application No. 10/223,549, filed on Aug. 19, 2002.

(51) Int. Cl. G06Q 40/00

(52) U.S. Cl. 705/36 R

(57) ABSTRACT

Disclosed is a system and method for calculating an intra-period volatility of a security. The system includes a means for collecting tick or selected time interval data from a data source, an interface or storage means for collecting or retrieving assumptions and variables used in the determination, and a processor programmed to perform iterative processes to determine the intra-period volatility and perform uses thereof. The steps of the method include receiving tick or selected time interval data from a data source, retrieving or inputting a set of assumptions for use in the calculations, simulating entering into a spread of options, and iteratively adjusting a variable in a pricing model to produce an intra-period volatility. The method may also include using the intra-period volatility in variety of option-related activities.

### BACKGROUND

The present disclosure relates to a system and method for calculating historical intra-period volatility for use in pricing and trading options using the Black-Scholes formula and variations thereof.

Methods of measuring volatility available today estimate volatility for a given interval, for a example a day, but fail to measure volatility throughout the interval. These methods include Close-to-Close methods which use the last price of the trading day when calculating volatility. Another method uses the highest and lowest prices from each day for calculating volatility. This method, also known as Parkinson's Volatility, fails to capture all movement during the course of day. Other methods including the Garman and Klass method also base their calculation on various selected values that occur during selected trading intervals. None of these methods provide an accurate volatility based on a series of trades and quotes made throughout a period.

There is therefore a need for a method which produces a realistic measure of volatility that is not limited by the arbitrarily selected times or prices of these previous methods. To illustrate, a calculation of volatility based on the Close-to-Close method described above with a stock closing yesterday at $100 and closing today at $100 would show a volatility of zero even if the stock has been trading at other prices throughout the day.

Volatility calculations are useful when a trader is using the Black and Scholes Model or variations thereof because all these model call for the trader to make a calculated assumption of the security's volatility. In one method of options trading, a trader calculates a theoretical value of an option. If a discrepancy is found between the trader's theoretical value and the current trading value, a trader may take a position in the option hoping to profit when the option reaches the trader's theoretical price. However, as the price of an underlying security, for example stocks or futures, changes, the trader must make adjustments to his position to retain the potential profit defined by the difference in the current trading price and the trader's theoretical option value. The volatility figure used to value the option position impacts the price and quantity of the underlying security that the trader will buy or sell for the purpose of maintaining or adjusting the position's profit potential and risk parameters. The volatility figure also impacts the price, quantity, and series of the option contracts that are traded for the purposes of maintaining or adjusting the position's profit potential and risk parameters.

Briefly, and in accordance with the foregoing, disclosed is a system and method for calculating an intra-period volatility of a security. The system includes a means for collecting tick or selected time interval data from a data source, an interface or storage means for collecting or retrieving assumptions and variables used in the determination, and a processor programmed to perform iterative processes to determine the intra-period volatility and perform uses thereof.

Also disclosed is a method for determining the intra-period volatility which is composed of a series of steps. The steps include receiving tick or selected time interval data from a data source, retrieving or inputting a set of assumptions for use in the calculations, simulating entering into a spread of options, and iteratively adjusting variable in a pricing model to produce an intra-period volatility. The method may also include using the intra-period volatility in variety of option-related activities.

Also disclosed is computer program embodiment of a method for determining the intra-period volatility which includes a number of software modules used to receive tick or selected time interval data, gather or retrieve assumptions related to the determination of the intra-period volatility, perform a simulation of entering into a spread of options for a particular security, and iteratively adjust variables used by the module to determine the intra-period volatility.

Also disclosed is a signal embodied in a carrier wave which includes data used to calculate an intra-period volatility as well as the resulting intra-period volatility itself.

Additional features will become apparent to those skilled in the art upon consideration of the following detailed description of drawings exemplifying the best mode as presently perceived.

### BRIEF DESCRIPTION OF THE DRAWINGS

The detailed description particularly refers to the accompanying figures in which:

FIG. 1 is a diagrammatic flowchart showing an overview of the method for calculating intra-period volatility;

FIG. 2 is a diagrammatic flowchart providing further details of the steps involved in selecting a hedging interval;

FIG. 3 is a diagrammatic flowchart further detailing the steps to execute a hedging strategy;

FIG. 4 is a diagrammatic flowchart providing further details into the steps involved with running a simulation at each hedging interval and calculating the scalping profit for each simulation;

FIG. 5 is a diagrammatic flowchart showing the steps involved with creating a theoretical options position containing a number of options;

FIG. 6 is a diagrammatic flowchart showing the steps toward setting an intra-period volatility to a calculated At-the-money volatility; and

FIG. 7 is a simplified diagrammatic view showing a system for calculating an intra-period volatility.

### DETAILED DESCRIPTION OF THE DRAWINGS

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the arrangements of components set forth in the following description or illustrated in the drawings.

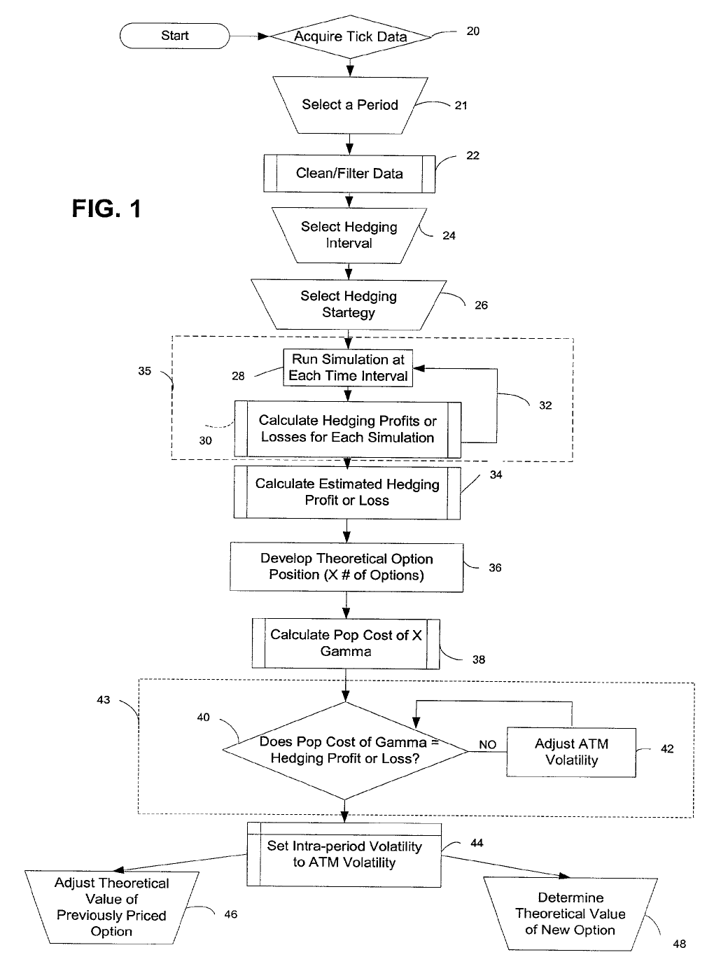

With reference to the figures, FIG. 1 provides a general diagrammatic overview of a method for calculating intra-period volatility of a security. The period 21 over which volatility is determined may be selected by the user to be one or more of a minute, hour, day, week, month, year, or multiple years. For simplicity, the description hereinafter shows the constants used to determine an intraday volatility, i.e. an intra-period volatility for one day. A security or underlying asset involved with intra-period volatility may include but should not be limited to following instruments: equity, bonds, loans, private placements, forward contracts, futures contracts, swaps, forward swaps/delayed start swaps, break forwards, calls, puts, straddles/strangles/butterflies, reverse floating rate loan/bull floating rate notes, dual currency bonds, callable/puttable bonds, puttable stock, bond with warrant, convertible bonds, liquid yield option notes, commodity-linked bonds, auction rate notes/debentures, collateralized mortgage obligations/real estate mortgage investment conduits, commercial real-estate backed bonds, credit enhanced debt securities, dollar bills, foreign exchange paper, floating/rate sensitive notes, floating rate tax-exempt revenue bonds, increasing rate notes, indexed currency option notes or principal exchange rate linked securities, caps/floors/collars, interest rate reset notes, mortgage pass-through certificates, negotiable certificates of deposit, adjustable tender securities, puttable/extendable notes, real yield securities, receivable pay-through securities, remarketed reset notes, stripped mortgage backed securities, stripped treasuries/municipals, variable coupon renewable notes, variable rate renewable notes, yield curve/maximum rate notes, adjustable rate preferred stock, auction rate preferred stock, convertible adjustable preferred stock, remarketed preferred stock, single point adjustable rate stock, state rate auction preferred stock, variable cumulative preferred stock, adjustable rate convertible debt, convertible exchangeable preferred stock, convertible reset debentures, debt with mandatory common stock purchase contracts, exchangeable preferred stock, synthetic convertible debt, zero coupon convertible debt, puttable common stock.

The method operatives by simulating entering into a of spread of options. Options involved with intra-period volatility may include but are not limited to the following types: vanilla options, Asian options, barrier options, binary options; chooser options, compound options, crack/spread options, currency translated options on U.S. or foreign “stripped” government securities divided into two or more instruments of principal and interest or price and dividend, options on stripped corporate, agency, and municipal securities, notes, bills and certificates of deposit, options on callables, and options on odd-first, -last, -middle, or securities with varying coupon/dividend periods.

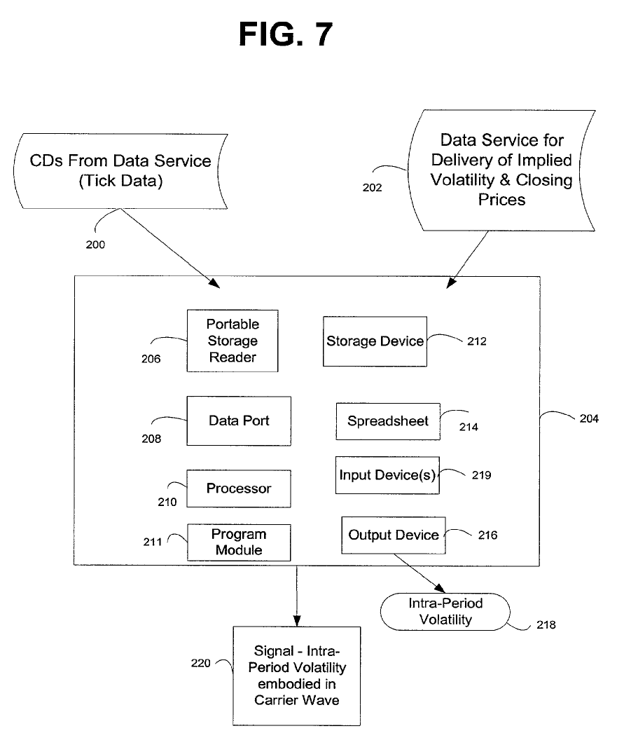

The method may be embodied in a computer program product for use with a general purpose computer of known construction. The steps of the method involved include acquiring tick or selected time interval data referred to hereinafter simply as tick data 20. As shown in FIG. 7, a computer-implemented system 204 includes a data port 208 for receiving tick data from the data service 202. The system 204 may be a computer or PC commonly available, but may also have other embodiments such as hand-held devices. Many methods for receiving tick data are known in the field and include but are not limited to receiving the data over the Internet or analogous communications network, receiving the tick data directly from a data provider, inputting the data by way of a storage medium such as a tape, cd-rom, or disk or manually entering the tick data.

This received data goes through a cleaning or filtering process 22 to remove data which may be unreliable. The system 204 includes a processor 210 programmed with software written to perform the screening. The filtering may be performed with a stand-alone program written in languages such as C++, Java, Fortran, Visual Basic or be implemented using a scripting language which supplements an off-the-shelf software package or spreadsheet 214 such as Microsoft Excel. In one embodiment, the filtering methodology is that bids or offers that over $0.50 different from a last known good bid or offer are ignored. Another example of this cleaning is that data on bids or offers made outside of regular trading hours are ignored.

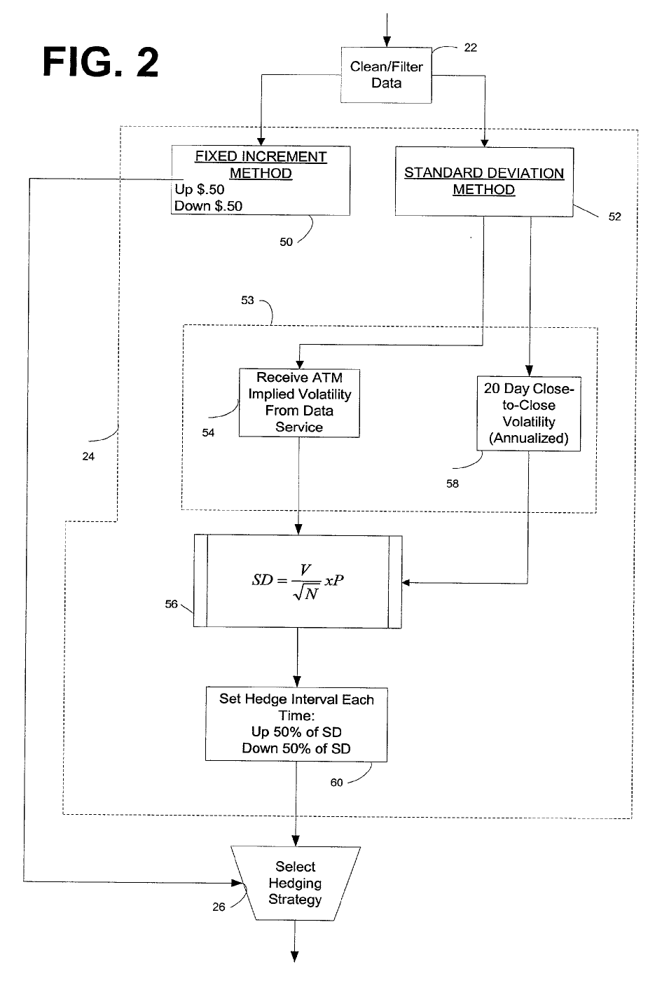

The next step of the method is for a user to select a hedging interval 24. A desired minimum change in intra-period price of the underlying security is selected by a user to use as a hedging interval. For determining an underlying security's movement through a hedge interval, price is defined as the bid price, if the underlying security price increases, or the ask price, if the underlying security decreases. It is at each of these hedging intervals that the method performs calculations described below. The selected hedging intervals will remain the same throughout the period. Of the many hedging intervals a user may select, two common intervals are described as exemplifications. As seen in FIG. 2, the first is a fixed increment method 50 in which a $0.50 hedge interval is selected.

Referring still to FIG. 2, a second common method for selecting a hedging interval is a standard deviation method 52. To determine the hedging interval using the standard deviation method 52, an annualized volatility 53 is selected. It may either be an at-the-money implied volatility received from a data service 54 or the most recent 20-day close-to-close volatility 58. The selected volatility depicted as “V’ in formula 56, is divided by the square root of the number of trading periods in a year, represented by “N”, then multiplying the result by the previous day's closing price (“P”). A hedging interval using this method will be said to be reached when the price changes a desired percentage of the daily standard deviation. The percentage used in this example is 50%, although other percentages may be used.

The hedging interval or calculation described above is stored on the system's 204 storage device 212. The processor 210 is programmed by whatever embodiment of the software program is selected by the user such as a scripting language in a spreadsheet or software code to use the hedging interval in the calculations and simulations that follow.

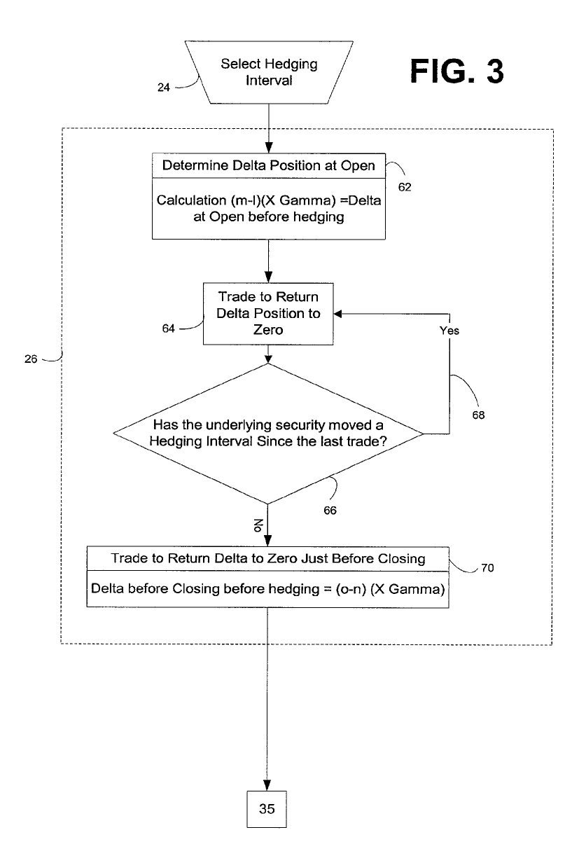

Referring now to FIG. 3, the next stage of the method for calculating the intra-period volatility is to run a simulation of a hedging strategy for each hedging interval. To do this, a hedging strategy is developed that simulates how a holder of an option position hedges his directional risk. This directional risk is known in the art as the option's delta. When using the Black-Sholes method introduced above, a purchase or sale of a theoretically mispriced option requires the purchase or sale of a hedging position to offset the change in price that occurs before expiration. The option's delta represents the ratio of the underlying security that must be traded to flatten or neutralize the risk associated with price changes.

The system 204 as shown in FIG. 7 may include software code or a program module 211 programmed to execute the hedging strategy selected by the user. Running a simulation using a hedging strategy involves hypothetically executing a series of trades and examining the profit or loss associated with each. This simple simulation technique is well known in the art and can be programmed using any of the programming languages or script-supplemented software packages described above.

A delta position is calculated at open 62 using methods commonly known by traders. Next, during the simulation, the simulation module 211 executes a trade 64 to return the delta to zero. This process is repeated for each hedging interval 66, and once again just before closing 70. The trades are recorded to the storage device 212 on the system 204 for use in calculating the estimated hedging profit or loss 34 in the next step 36.

Also during the simulation, the option is described as having reached a hedge interval using the following methodology. Tick data including trade and quote prices is received from a data provider 200 as shown in FIG. 7. A first hedge interval is said to have been reached as soon as when the absolute difference between the most recently quoted price and the price at which the security opened is equal to or greater than the hedge interval chosen for the simulation. This change in price must also be accompanied by a sufficient quantity of the underlying security traded or quoted at the most recent price. The calculation of sufficient quantity is dependant on an selected amount of Gamma.

Gamma is defined as the rate of change of underlying security's delta per unit change in the price of the underlying asset. The amount of Gamma selected for the simulation may differ depending on the user's strategy, although those in the trading industry are familiar with selecting a desired amount of Gamma depending on their strategy. As an example, the minimum amount of Gamma that could be used in one embodiment equals one price unit in which the underlying security trades divided by the smallest hedge interval that is being simulated. The price unit is expressed in the price unit in which the underlying security trades. An example of a price unit is a dollar, and for clarity, price units will be referred to as dollars hereinafter, although other price units such as currencies from other countries, may be utilized. The maximum amount of Gamma that could be used is dependant on the liquidity of the underlying security. In one embodiment, the amount should not exceed one-hundredth of the average daily volume of the underlying security. For simplicity, the selected amount of Gamma is referred to hereinafter as X Gamma. The selected X Gamma is stored on the system's 204 storage system 212 for use in calculating the intra-period volatility.

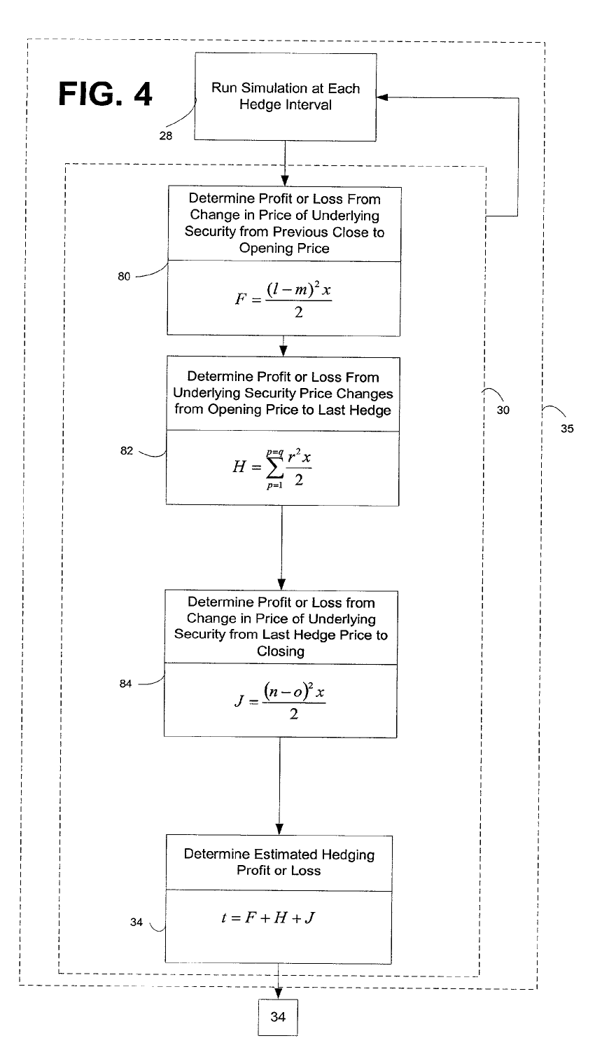

As seen in FIG. 4, during the simulation a hedging profit or loss is calculated at each hedging interval 34. The profit is calculated based on hedging a theoretical option position with an amount of Gamma, referenced in the Figures as the variable “X”. A standard approximation formula known in the art is used. In one embodiment, this formula is based on the following assumptions. First, the Gamma of the position remains relatively constant over the relevant price range of the underlying asset. Second, the position delta before the price change was zero. Third, the average position delta over the price range for which profit or loss is being calculated is equal to one-half of the Gamma multiplied by the price change. The formula operates as follows. First, the interval over which the security moves is expressed in the units it trades in, in this embodiment as an example, the interval is in dollars.

In an embodiment where the selected period is one day, the system 204 uses three different formulas to calculate the hedging profit or loss depending on the movement of the underlying security and the type of profit or loss made. The first formula 80 is used to calculate the dollars of profit or loss earned on an X Gamma position achieved from the change in price of the underlying asset when there is a change between the opening price and the previous day's closing price. The variables in the formula 80 represent the following:

TABLE I

| Variable | Meaning |
|---|---|
| F | Profit or loss from formula 80. |
| l | Previous day's closing price in dollars. |
| m | Day of simulation's opening price in dollars. |
| x | Selected amount of gamma. |

A second formula 82 is used to calculate the dollars of profit or loss earned on an X Gamma position achieved from the underlying asset price changes between the opening price and last hedge price. The variables in the formula 82 represent the following:

TABLE II

| Variable | Meaning |
|---|---|
| H | Profit or loss from formula 82. |
| p | Sequential hedging interval used during simulation. |
| q | Number of times the underlying asset price moved at |
| | least as much as the hedge interval during the day |
| | of simulation. |
| r | Hedge interval in dollars. |
| x | Selected amount of Gamma. |

A third formula 84 is used to calculate the dollars of profit or loss earned on an X Gamma position achieved from the change in price from the last hedge price of the day of simulation to the closing price. The variables in the formula 84 are represented by the following:

TABLE III

| Variable | Meaning |
|---|---|
| J | Profit or loss from formula 84. |
| n | Last hedge price, or if there were no hedges that |
| | day, the opening price. |
| o | Day of simulation's closing price in dollars. |
| x | Selected amount of Gamma. |

The profit or loss values from formulas 80, 82 and 84 are summed for each hedging interval simulated and stored on the system's 204 storage device 206. The summed profit or loss values of each of the hedging simulation are averaged to yield the estimated hedging profit or loss 34 for that day which is stored on the system's 204 storage device 212. The estimated hedging profit or loss is then used to enter into a theoretical option position.

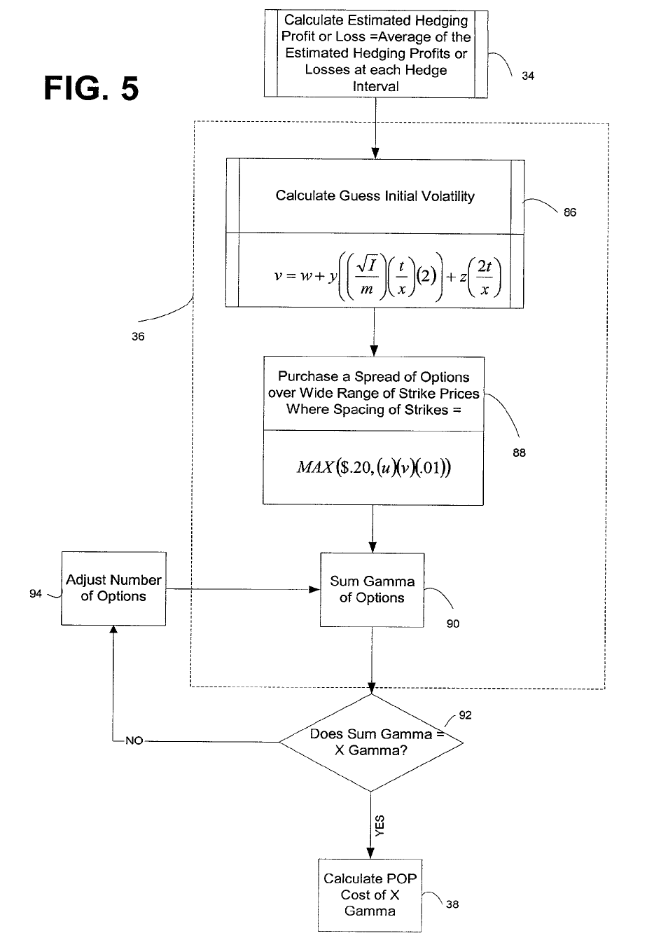

Referring now to FIG. 5, the first step in entering into the theoretical option position is to use the system 204 to calculate a guess initial volatility using a regression formula 86. The variables of the formula 86 represent the following:

TABLE IV

| Variable | Meaning |
|---|---|
| w | Regression constant. |
| y | Regression coefficient; the amount that v changes for |
| | every unit change in (sqrt(I)/m)*(t/x)*2 assuming |
| | 2t/x is held constant. |
| z | Regression coefficient; the amount that v changes for |
| | every unit change in 2t/x assuming (sqrt(I)/m)*(t/x)*2 |
| | is held constant. |
| m | Day of simulation's opening price in dollars. |
| t | Estimated hedging profit or loss. |
| x | Amount of Gamma. |
| v | Guess volatility. |
| I | Number of trading days to expiration. |

The guess volatility is then used by the system 204 in a calculation 88 to simulate entering into a spread of options over a wide range of strike prices where spacing of the options is the maximum of a selected currency amount, for example twenty cents, and the value of a security multiplied by the at-the-money volatility multiplied by a factor, such as 0.1. A position length is calculated by the system 204 at a point where the marginal change in daily decay is small relative to increases in the position length. The length of time that is used for this embodiment of the method is 143 trading days although other quantities of days may be used. Although any type of options may be used, in one embodiment, the type of option in a straddle.

For all option calculations done in the foregoing steps, the system 204 uses the risk-free rate for the day of simulation. In one embodiment, this interest rate is received by the data port 208 on the system 204, from a data service. In another embodiment, the interest free rate is read from a portable storage reader 206. In yet another embodiment, the interest rate is inputted into the system 204 using an input device 219. The interest rate used generally matches, as closely as possible, the time to expiration of the option being calculated with the maturity of the risk-free security.

Continuing to refer to FIG. 5, during the simulation, the system 204 calculates the number of options in the position at each strike price using an iteration process which compares the sum 90 of the Gamma of the options in the position to X Gamma. The system 204 may be provided with a module 213 to perform this iteration and comparison process. In one embodiment, this module is stand-alone software. In another embodiment, a script-supplemented spreadsheet is used. A comparison 92 is performed by the system 204 to compare the sum of the Gammas of the options in the theoretical positions to X Gamma. The Gammas of the positions may be calculated using commonly known methods of calculating Gamma by the system 204 or received from a data service. If the two are not equal, an adjustment 94 to the number of options in the theoretical position until total Gamma of the options in the position is equal to X Gamma.

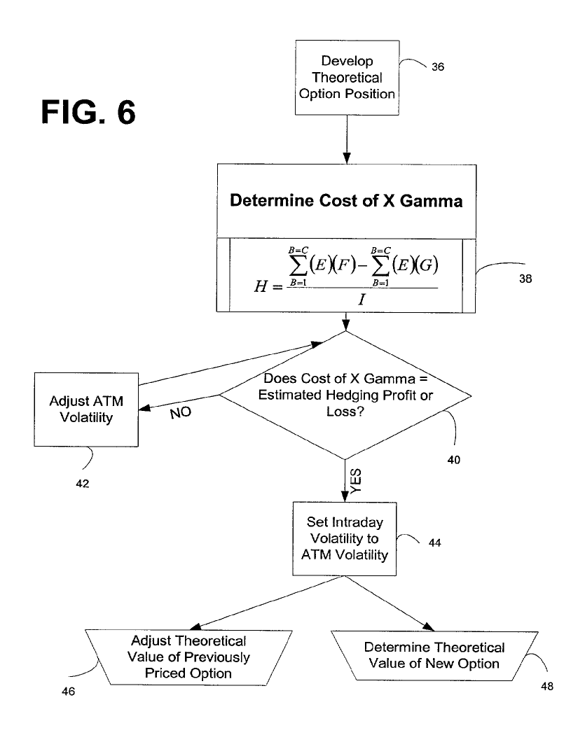

Referring now to FIG. 6, after the number of options has been calculated, the carrying cost of holding the theoretical position is calculated. This carrying cost, referred to Cost of X Gamma, is calculated by the system 204 using a formula 38. The Cost of X Gamma is based on the premium over parity which is the sum of theoretical values of all the options in the position reduced by the sum of the intrinsic value of all the options in the position. The intrinsic value of a call option is equal to an amount the underlying security price is higher than the strike price and the intrinsic value of a put option is equal to the amount the underlying security price is lower than the strike price. The system 204 calculates the Cost of X Gamma by taking the premium over parity divided by the number of trading days to expiration. The variables in the formula 38 represent the following:

TABLE V

| Variable | Meaning |
|---|---|
| B | An indicative serial integer that represents each strike |
| | used in a theoretical option position. |
| C | Number of strikes in the theoretical position. |
| E | Number of options per strike. |
| F | Theoretical value of option (using V for volatility input). |
| G | Parity value of straddle. |
| I | Number of trading days to expiration. |

In one embodiment the value of the straddle and parity value of the straddle, represented by variables F and G respectively, is calculated using the Cox-Ross-Rubinstein Binary Model option formula (Haug, Espen Gaarder, “The Complete Guide to Options Pricing Formulas”, McGraw-Hill, 1998; pp 229-263.). This model uses an iterative process to calculate an option's theoretical value. In this example, the C-R-R value is taken from 20 iterations and 21 iterations. Those familiar with the art are aware that the determinants of the option values are the price of the underlying asset, strike price, time to expiration, volatility, interest rate and dividends. Other models commonly known in the art may be used to calculate the value of the options and the parity values of the options in the theoretical option position. For simplicity, the model chosen will be referred to as the valuation model formula.

The system 204 next performs an iteration process to make a comparison 40 of the Cost of X Gamma to the estimated hedging profit or loss adjusting 42 only an at-the-money volatility (“ATM Volatility”) in the valuation model formula. At the beginning of the iteration, the ATM Volatility is set to the Guess volatility (v from above). When the Cost of X Gamma and estimated hedging profit or loss are equal, the ATM volatility at that point is the intra-period volatility 44.

Uses of the intra-period volatility include adjusting the theoretical value of a previously priced option 46, determining the theoretical value of a new option position 48, determining the efficiency of option market-makers or specialists, input into volatility forecast models such as GARCH (Generalized Auto Regressive Conditional Heteroskedasticity) or determining the risk of a position in the underlying asset.

Referring now to FIG. 7, a system 204 for implementing the above method includes a portable storage reader 206 such as, for example, a floppy disk, CD-ROM, CDR, DVD, DVDR, DVD+RW, tape, memory stick, or removal hard drive containing historical tick data. This portable storage reader 206 communicates with a processor 210 to perform a number of calculations to determine an intra-period volatility. The system 204 may also include a spreadsheet program 214 or program module 211. The term “module” referenced in this disclosure is meant to broadly cover various types of software code including but not limited to routines, functions, objects, libraries, classes, members, packages, procedures, or lines of code together performing similar functionality to these types of coding. A storage device 212, such as, for example, a floppy drive, hard drive, tape drive, a CDR, or a CDRW, is also included for recording variables, positions, and other purposes to retrieve and calculate needed information. Tick data required for this calculation may be received via CD-ROM or other portable storage media from a data service such as Reuters or New York Stock Exchange TAQ Database or over a communications network such as the Internet by a data port 208, such as, for example, a network card, a serial port, parallel port, firewire port, or network card configured to communicate with a network wirelessly. Certain other values needed to calculate the intra-period volatility 218 such as at-the-money implied volatility may also be received by the system 204 from data services such as Bloomberg.

The system 204 also includes an output device 216, such as, for example, a monitor or printer, or network interface which prompts the user for calculation-determinative assumptions, i.e. hedging intervals, selected amount of Gamma, etc., and to output the intra-period volatility after being determined. The system 204 also includes one or more input devices 219, such as, for example, a keyboard and mouse, to allow a user to communicate with the system 204.

The system 204 may also include a translating device, such as for example, a compression chip on a network card, for translating the intra-period volatility and other data involved with determining the intra-period volatility into a digital data signal 220. The data signal may be transmitted via a carrier wave remotely to a general purpose computer. Upon receiving the data signal 220, the intra-period volatility contained therein may be used for one or more of the purpose described above. For example, the data signal 220 may be received by a remote computer which is programmed to buy or sell options. The remote computer might receive the intra-period volatility in the data signal 220, calculate the price of an option using the intra-period volatility, and execute a buy or sell when there is a favorable discrepancy, such as buying an option being sold below its calculated value.

The data signal 220 may be configured to operate over commonly used network or communications protocols, such as TCP/IP or IPX. With such protocols, the system 204 processes the data signal 220 into a compressed signal of various length codewords, encrypts the compressed signal, and transmits compressed and encrypted signal to the remote computer. The remote computer is programmed to decompress and decrypt the data signal so that the intra-period volatility can be utilized.

While preferred embodiments of the disclosure are shown and described, it is envisioned that those skilled in the art may devise various modifications and equivalents without departing from the spirit and scope of the disclosure as recited in the following claims.

What is claimed is:

1. A method of determining an intra-period volatility of a security, the method comprising the steps of:
(a) selecting a period;
(b) acquiring tick data from a data source;
(c) selecting a set of hedging intervals within the period;
(d) selecting a hedging strategy;
(e) selecting an amount of Gamma for a theoretical option position;
(i) iteratively running a simulation at each hedging interval;
(g) calculating a hedging profit or loss at each simulation;
(h) calculating a number of options to enter into a theoretical option position having the selected amount of Gamma;
(i) calculating a premium over parity cost of the options in the theoretical option position;
(j) iteratively adjusting an at-the-money volatility in a selected valuation model until the pop cost for the theoretical position equals the hedging profit or loss; and
(k) setting the intra-period volatility to the at-the-money volatility when the pop cost for the theoretical position equals the hedging profit or loss.

2. The method of claim 1, wherein the tick data is filtered after being acquired.

3. The method of claim 1, wherein the hedging interval is based on a selected fixed increment.

4. The method of claim 1, wherein the hedging interval is calculated using a method based on standard deviation.

5. The method of claim 4, wherein a historical volatility used to calculate the hedging interval is an at-the-money volatility received from a data service.

6. The method of claim 4, wherein a historical volatility used to calculate the hedging interval is a close-to-close volatility from a number of days prior to a date of calculating the intra-period volatility.

7. The method of claim 4, wherein a daily standard deviation used to calculate the hedging interval is calculated by dividing a selected volatility by a square root of a number of trading days in a year multiplied by a previous day's closing price.

8. The method of claim 7, wherein the hedge interval is set to a selected percentage of the daily standard deviation.

9. The method of claim 1, wherein the hedging strategy is based on a trader holding a long option position and making adjustments to the long option position when the hedge interval is reached.

10. The method of claim 1, wherein the hedging strategy is based on a trader holding a short option position and making adjustments to the short option position when the hedge interval is reached.

11. The method of claim 1, wherein the development of the theoretical option position is further comprised of using a calculated guess volatility to enter a position consisting of a number of options having strikes spaced at maximum of either a selected currency amount or a value of the security multiplied by an at-the-money volatility multiplied by a factor.

12. The method of claim 11, wherein a time to expiration for the options in the theoretical option position is selected at a length where the marginal change of daily decay with changes in the time to expiration is minimal.

13. The method of claim 11, wherein a time to expiration for the options in the theoretical option position is a number of business days.

14. The method of claim 11, wherein the number of options in the theoretical option position is calculated by iteratively adjusting a number of options until a total amount of Gamma for the options in the theoretical option position is approximately equal to the amount of Gamma.

15. The method of claim 11, wherein the at-the-money volatility is retrieved from a data service.

16. The method of claim 11, wherein the at-the-money volatility is calculated using the last twenty days close-to-close volatility.

17. A method of determining an intra-period volatility of a security, the method comprising the steps of:
(a) selecting a period;
(b) acquiring options from a data source;
(c) selecting a set of hedging intervals within the period;
(d) selecting a hedging strategy;
(e) selecting an amount of Gamma for a theoretical option position;
(f) iteratively running a simulation at each hedging interval;
(g) calculating a scalping profit or loss at each simulation;
(h) calculating a number of options to enter into a theoretical option position having the amount of Gamma by iteratively adjusting a number of options until a total amount of Gamma for the options in the theoretical option position is approximately equal to the amount of Gamma;
(i) calculating a premium over parity cost for the options in the theoretical option position;
(j) iteratively adjusting an at-the-money volatility in a selected valuation model until the pop cost for the theoretical position equals the hedging profit or loss;
(k) setting the intra-period volatility to the at-the-money volatility when the pop cost for the theoretical position equals the hedging profit or loss; and
(l) making an options-related use of the intra-period volatility.

18. The method of claim 17, wherein the options-related use is to adjust a theoretical value of an option.

19. The method of claim 17, wherein the options-related use is to determine an efficiency of an option market maker.

20. The method of claim 17, wherein the options-related use is to use the intra-period volatility in a forecast model.

21. The method of claim 17, wherein the options-related use is to determine the risk of a position in the security.

22. A system for determining an intra-period volatility of a security comprising: means for storing data, an output interface for prompting a user for calculation-determinative assumptions and receiving those assumptions from the user; a means for receiving data; memory; a program module; an input device; a processor responsive to a plurality of instructions from the program module, being operative to:
prompt the user via an output interface for a period; receive by a first signal from the input device the period;
receive tick data from a data source;
prompt the user via an output interface for instructions for a hedging interval;
receive by a second signal from the input device the instructions for the hedging interface;
prompt the user via the output interface for instructions for a hedging strategy;
receive by a third signal from the input device the instructions for the hedging strategy;
prompt the user via the output interface for an amount of Gamma; receive by a fourth signal from the input device the amount of Gamma;
run iteratively a simulation on the tick data utilizing the hedging strategy at each hedging interval;
calculate a hedging profit or loss at each simulation;
prompt the user via the output interface for instructions for a valuation model and receive by a fifth signal from the input device the instructions for the valuation model;
simulate entering into a theoretical option position of options having the amount of Gamma;
adjust iteratively the number of options in the theoretical option position until a total Gamma in the theoretical option position equals the amount of Gamma;
store the number of options on the means for storing data;
calculate a premium over parity cost for the options in the theoretical option position and store the premium over parity cost on the means for storing;
adjust iteratively an at-the-money volatility in a selected valuation model until the pop cost for the theoretical position equals the hedging profit or loss; and
set the intra-period volatility to the at-the-money volatility when the pop cost for the theoretical position equals the hedging profit or loss.

23. The system of claim 22, wherein the processor is also operative to filter the tick or selected time interval data.

24. A system for determining an intra-period volatility of a security comprising: means for storing data, a means for receiving data; memory; a program module; a processor responsive to a plurality of instructions from the program module, being operative to:
retrieve a period receive tick data from a data source;
retrieve a set of hedging intervals from the memory;
retrieve a hedging strategy from the memory;
retrieve an amount of Gamma from the memory;
run iteratively a simulation on the tick data utilizing the hedging strategy at each hedging interval;
calculate a hedging profit or loss at each simulation;
retrieve a formula for a valuation model;
simulate entering into a theoretical option position with a number of options;
adjust iteratively the number of options until a total Gamma in the theoretical option position equals the amount of Gamma;
store the number of options on the means for storing;
calculate a premium over parity cost for the options in the theoretical option position and store the premium over parity cost on the means for storing;
adjust iteratively an at-the-money volatility in the formula for the valuation model until the pop cost for the theoretical position equals the hedging profit or loss; and
set the intra-period volatility to the at-the-money volatility when the at-the-money volatility equals the scalping profit.

25. The system of claim 24 wherein the processor is also operative to filter the tick data.

26. The system of claim 24 wherein the processor further operative to produce a carrier wave comprising: instructions for receiving an object transmitted via carrier wave and an object representing the intra-period volatility.

27. A computer program product for use with a computer, said computer program product comprising:
a module for storing and retrieving a period;
a module for accessing tick data from external source;
a module for storing and retrieving a set of hedging intervals;
a module for storing and retrieving a hedging strategy;
a module for iteratively running a simulation on the tick or selected time interval data utilizing the hedging strategy at each hedging interval;
a module for calculating a hedging profit or loss at each simulation;
a module for storing and retrieving an amount of Gamma from the memory;
a module for simulating entering into a theoretical option position with a number of options to be stored on the means for storing having the amount of Gamma;
a module for calculating a premium over parity cost for the options in the theoretical option position and storing and retrieving the premium over parity cost;
a module for storing and retrieving formula for a valuation model;
a module for adjusting iteratively an at-the-money volatility in the formula for the valuation model until the pop cost for the theoretical position equals the hedging profit or loss;
a module for setting the intra-period volatility to the at-the-money volatility when the pop cost for the theoretical position equals the hedging profit or loss and storing and retrieving the intra-period volatility.

28. The computer program product of claim 27 further comprising a module for outputting the intra-period volatility.

29. A data signal embodied in a carrier wave claim comprising:
instructions for receiving objects transmitted by carrier wave and an intra-period volatility value, the intra-period volatility including:
a period;
tick data;
a hedging interval;
a hedging strategy, wherein a simulation and calculation of a hedging profit or loss is performed at each hedge interval using the hedging strategy;
a selected an amount of Gamma;
a theoretical option position containing an amount of options having the amount of Gamma; and
an at-the-money volatility wherein a premium over parity cost for the options in the theoretical option position is equal to a hedging profit or loss.
